(19) United States
(12) Patent Application Publication
(10) Pub. No.: US 2008/0147639 A1
(43) Pub. Date: Jun. 19, 2008

(54) Method and apparatus for organizing a contact list by weighted service type for use by a communication device

(75) Inventors: Robert A. Hartman, Cooper City, FL (US); Steven A. Zaccardi, Coral Springs, FL (US)

Correspondence Address: BRINKLEY, MORGAN, SOLOMON, TATUM, etal., 200 E. LAS OLAS BLVD., SUITE 1900, FORT LAUDERDALE, FL, 33301, US

(73) Assignee: Motorola, Inc.

(21) Appl. No.: 11/641,360

(22) Filed: Dec. 19, 2006

(51) Int. Cl. G06F 17/30; G06F 7/00; G06F 3/048; G06F 13/00

(52) U.S. Cl. 707/5; 707/101; 715/764; 719/313; 707/E17.032; 707/E17.084

(57) ABSTRACT

A communication device (104, 106) or communication system (100) employs a method for automatically organizing a contact list for use by the communication device (104, 106). A plurality of contact records are stored in a memory. Each contact record is associated with a corresponding contact and includes one or more contact entries. Each contact entry is further associated with at least one service type. A respective weighting factor is assigned to each contact entry of the contact record. Each weighting factor relates to communication activity involving a contact identified by the particular contact record and a service type (e.g., phone, text, etc.) associated with the contact entry. The contacts are ordered based on the weighting factors for a desired service type. In one embodiment, the ordered contact list is displayed to a user to facilitate communication with one or more of the contacts.

### FIELD OF THE INVENTION

The present invention relates generally to wireless and/or wireline communication systems and more particularly to a method and apparatus for organizing and displaying contacts in a list based on service type and communication frequency.

### BACKGROUND OF THE INVENTION

Communication systems today are more prevalent and far-reaching than ever. It has become increasingly important and, in many cases, literally expected to be able to communicate with someone at a moment's notice. As a result, people often have a variety of ways in which to communicate with others. For example, a person may have a cellular phone which can also include a dispatch number for push-to-talk (PTT) access, a personal data assistant (PDA), a home phone, a business phone, one or more fax machines, several different email addresses, and several instant messaging ID's.

As the number and variety of communication mechanisms continue to grow, the more complicated it becomes to keep track of all of the contact information for each person that someone may want to reach. Most messaging systems, such as cellular phones or email, currently have a “contacts” list to store information for people with whom the user communicates. Generally, the user enters the name of each person or business with whom he or she communicates (generally referred to as a “contact”), along with various contact information for each contact, into a record. The collection of records is then arranged into a contact list. Each contact may have several means of communication and, therefore, several pieces of contact information. For example, “John Smith” may have a phone number and an email address, while “Jane Smith” may have an email address, an instant message ID, and a dispatch number. Each piece of contact information is typically entered as a separate entry in the particular contact's record. However, in present communication devices (e.g., wireless phones, PDAs, and computers), all the contacts, regardless of service type, are arranged in one master list.

Existing contact lists are typically arranged in alphabetical order according to each contact's name. Thus, as a user's personal network of contacts grows, so does the user's contact list. To initiate a call or message from the contact list, the user selects the recipient from the list. In many instances, the user must scroll through a very long listing before finding the name of the desired recipient. When the listing is displayed on a cellular phone, the small size of the display screen significantly limits the amount of contact records that can be shown at one time. The listing can become quite cumbersome to manipulate when the user stores all of his contact information, including numbers not often called, on one device.

Additionally, certain entries in the contact list may be used primarily for certain services. For example, a user may send text messages to one contact quite frequently, but seldom call the person. However, in prior art contact lists, all contacts, regardless of service type, are displayed. Showing all contacts increases the length of the list and exacerbates the problem for users that have many contacts. When the user wishes to contact a person that he or she primarily communicates with only through text messaging, it becomes quite frustrating to sort through all the phone contacts before finding the desired messaging contact.

Many phones or messaging systems also keep a running list of the most recent calls. However, these lists, like contact lists, contain information for all contacts recently called, regardless of service type. As a result, recent call lists can become very long also.

Therefore, a need exists for a method and apparatus that more efficiently organize contact lists to overcome the shortcomings of the prior art.

### SUMMARY

Generally, the present invention encompasses a method and apparatus for automatically organizing a plurality of contacts for use by a communication device. In accordance with one embodiment, a plurality of contact records are stored for use by the communication device. Each contact record is associated with a corresponding one of the contacts, and includes one or more contact entries. Each contact entry is further associated with at least one service type. A respective weighting factor is assigned to each contact entry of the contact record. Each weighting factor relates to communication activity involving a contact identified by the particular contact record and a service type (e.g., phone, text, multimedia, or dispatch) associated with the contact entry. The contacts are ordered based on the weighting factors for a desired service type.

Each contact record may include a contact name and at least one of a telephone number, an email address, an instant messaging address, a group identifier, a universal fleet member identifier (UFMI), and a dispatch number. Service types may include telephone calls, email, text messaging, multi-media messaging, instant messaging, and dispatch. The communication activity includes, inter alia, a quantity of communications, a length of communications, a time lapsed since last communication, and an origination of communication.

In one embodiment, the method further stores the ordered list of contacts in a memory of the communication device, wherein the memory is either internal to the communication device or connectable to the communication device.

In another embodiment, the method displays the ordered list of contacts to a user on a display screen of the communications device. The user is able to initiate a communication by selecting a displayed contact.

In a further embodiment, the method includes excluding from the ordered list any contact when the assigned weighting factor of the contact entry for the desired service type is less than a predetermined value, when the time lapsed since the last communication using the desired service type exceeds a predetermined period of time, or when the ordered list is limited to a predetermined number of contacts, any contact for which the assigned weighting factor of the contact entry for the desired service type is lower than assigned weighting factors of at least some of the other contact entries for the desired service.

In one embodiment, when the ordered contacts have assigned weighting factors of equal value for the desired service type, the contacts are ordered by alphabetical order according to a contact name, a time lapsed since last communication, a quantity of communications, or a length of communication.

In a further embodiment, the method includes updating the ordered contact list by communicating with a first contact in the ordered list using the desired service type, assigning a new weighting factor to a contact entry in a contact record associated with the first contact, the new weighting factor determined in response to the step of communicating, and re-ordering the ordered list contacts to take into account the new weighting factor assigned to the contact entry for the first contact.

In another embodiment, the method automatically completes a request from the user in response to the entry of at least one alphanumeric character, by displaying a contact name of a contact from the ordered list of contacts to a user, wherein the displayed contact name includes at least one textual character associated with the at least one alphanumeric character.

In a further embodiment, the method orders a plurality of contacts into a second list based on the assigned weighting factors for a second desired service type.

In another embodiment, a wireless communication device contains a memory for storing a plurality of contact records for a plurality of contacts, each contact record being associated with a corresponding contact and including one or more contact entries, each contact entry being associated with at least one service type, and a processor communicatively coupled to the memory, the processor assigning a respective weighting factor to each contact entry of each contact record to produce assigned weighting factors relating to communication activity involving a contact identified by the particular contact record and a service type associated with the contact entry, and ordering the plurality of contacts into an ordered list based on the assigned weighting factors for a desired service type.

The device further contains a display screen for displaying the ordered list of contacts to a user and a user interface for facilitating user selection of a displayed contact from the ordered list of contacts.

### BRIEF DESCRIPTION OF THE DRAWINGS

FIG. 1 is a block diagram of an exemplary communication system that may employ the method and apparatus of the present invention.

FIG. 2 is a block diagram illustrating an exemplary mobile or wireless communication device used in the system of FIG. 1, according to one embodiment of the present invention.

FIG. 3 depicts an exemplary contact record containing weighting factors for contact entries associated with different services types, in accordance with an exemplary embodiment of the present invention.

FIG. 4 is an operational flow diagram illustrating portions of a method for assigning weighting factors to contact entries for a particular service type, in accordance with an exemplary embodiment of the present invention.

FIG. 5 depicts an exemplary look-up table containing values for weighting factors, in accordance with an exemplary embodiment of the present invention.

FIG. 6 is an operational flow diagram illustrating portions of a method for constructing a frequent contacts list based on a weight indicating an amount of usage for a particular service type, in accordance with an exemplary embodiment of the present invention.

FIG. 7 is an operational flow diagram illustrating an exemplary sequence of use for performing the method of FIG. 6.

### DETAILED DESCRIPTION

Before describing in detail exemplary embodiments that are in accordance with the present invention, it should be observed that the embodiments reside primarily in combinations of apparatus components and processing steps related to implementing a method and system for automatically organizing a plurality of contacts for use by a communication device. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, are used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

The term “communication device” is intended to broadly cover many different types of devices that can receive and/or transmit signals and that can operate in a wireless and/or wireline communication system. For example, and not for any limitation, a communication device can include any one or a combination of the following: a cellular telephone, a mobile phone, a smart phone, a two-way radio, a two-way pager, a wireless messaging device, a laptop/computer, an automotive gateway, a residential gateway, a personal computer, a server, a personal digital assistant (PDA), a router, a cordless telephone, a wired telephone, a wireless email device, a portable gaming device including a built-in wireless modem, and the like. Moreover, the term “dispatch number” includes any identification sequence used to identify a wireless communication device with any “push-to-talk” services, including but not limited to Voice-over-IP applications.

It will be appreciated that embodiments of the invention described herein may be comprised of one or more conventional processors and unique stored program instructions that control the one or more processors to implement, in conjunction with certain non-processor circuits, some, most, or all of the functions of automatically organizing a plurality of contacts as described herein. The non-processor circuits may include, but are not limited to, a radio receiver, a radio transmitter, signal drivers, clock circuits, power source circuits, and user input devices. As such, these functions may be interpreted as steps of a method to automatically organize contacts based on per-service weighting factors. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) without undue experimentation.

Most wireless communication devices store a contacts database containing the names and other personal information for persons and businesses with whom the user communicates. Generally, each contact record in the database is associated with one or more contact entry types, such as one or more telephone numbers, an email address, an instant message identifier, a universal fleet member identifier, a group ID, and/or a dispatch number. For many users, the contacts database is quite large because the user has an entry in the database for almost every person with whom he/she communicates. However, in actuality, the user only communicates with a small subset of the contact database on a frequent basis. Additionally, the user may only communicate with a particular contact in a limited number of ways. For example, “Mary” may have an email address, two phone numbers, and a dispatch number, but the user only talks to Mary by one phone number. However, for “Bob,” the user primarily sends text messages, but occasionally speaks with Bob on the phone. Whenever the user wishes to speak to Mary, he/she must scroll through a long list of contacts, including seldom phoned listings, before reaching the desired listing for Mary. An embodiment of the present invention teaches a method of associating a weight that represents a frequency of communication with each contact entry type. This weight association is also broken down by service type, allowing for each contact entry of a contact record to have independent weights based on the different services. In this manner, a frequently called list is created for each service type, enabling the user to select a desired contact more quickly and efficiently.

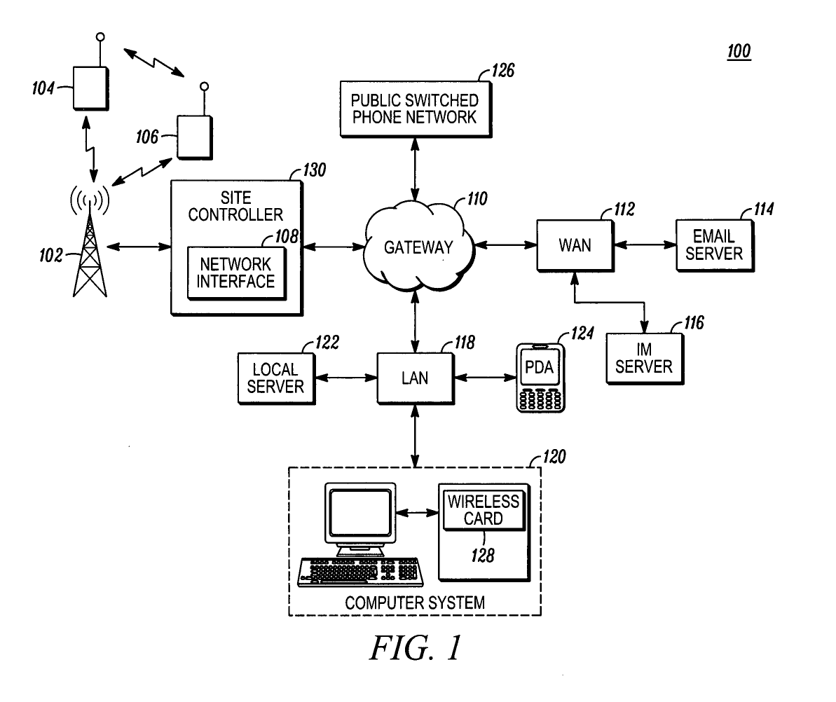

The present invention can be more readily understood with reference to FIGS. 1-7, in which like reference numerals designate like items. FIG. 1 depicts an exemplary communication system 100 in accordance with one embodiment of the present invention. The exemplary communication system 100 connects wireless communication devices 104, 106 to other wireless communication devices and/or to other networks, such as a wide area network (WAN) 112, a local area network (LAN) 118, a public switched telephone network 126, and the like, via a gateway 110. The communication system 100 includes, inter alia, a mobile phone network, mobile text messaging device network, a pager network, or the like. Additionally, the wireless communication devices 104, 106 may have the ability to communicate with each other directly, without routing information through the communication system 100.

The communications standard or protocol of the wireless portion of the communication system 100 may be any conventional protocol or multiple access technique, including, without limitation, Code Division Multiple Access (CDMA), Time Division Multiple Access (TDMA), Global System for Mobile Communications (GSM), Enhanced Data GSM Environment (EDGE), General Packet Radio Service (GPRS), Frequency Division Multiple Access (FDMA), Orthogonal Frequency Division Multiplexing (OFDM), or the like. Additionally, the wireless portion of the communication system 100 may further utilize text messaging standards, such as, for example, Short Message Service (SMS), Enhanced Messaging Service (EMS), Multimedia Messaging Service (MMS), or the like. The wireless portion of the communication system 100 may further allow for push-to-talk communications between capable wireless communication devices.

The wireless portion of the communication system 100 also includes at least one base station 102 that is, for example, operated by a site controller 130 connected to the communication system 100 via a network interface 108. The network interface 108 can be wired or wireless, using communication standards including, but not limited to, the IEEE 802.11b and g (Wi-Fi) standards and/or the IEEE 802.16e (Wi-MAX) standard.

The communication network 100 supports any number of wireless communication devices 104, 106 and/or wireline communication devices (e.g., PCs). The support of the wireless communications network 100 includes support for mobile telephones, smart phones, text messaging devices, handheld computers, pagers, beepers, wireless communication cards, or the like. A smart phone 124 is a combination of 1) a pocket PC, handheld PC, palm top PC, or Personal Digital Assistant (PDA), and 2) a mobile telephone. More generally, a smart phone can be a mobile telephone that has additional application processing capabilities. A wireless communication card 128, in one embodiment, resides within a personal computer 120.

Each wireless communication device 104, 106 generally contains a database of the user's personal contacts, usually in the form of an electronic phone book or address book. Typically, the information stored in the contact database includes the names of the persons or businesses with whom the user communicates on a regular basis, and any associated information needed to contact them (e.g., one or more telephone numbers, an instant messaging identifier, an email address, and/or a dispatch number for push-to-talk contact). Additionally, certain wireless communication devices 104, 106 may contain a listing of the most recently used numbers or addresses.

In one embodiment, the contact database can be stored external to the wireless communication device 104, 106 on a local server 122 connected by a local area network 118. Additionally, other remote servers, such as an email server 114 or instant messaging server 116, may contain the user's contact database.

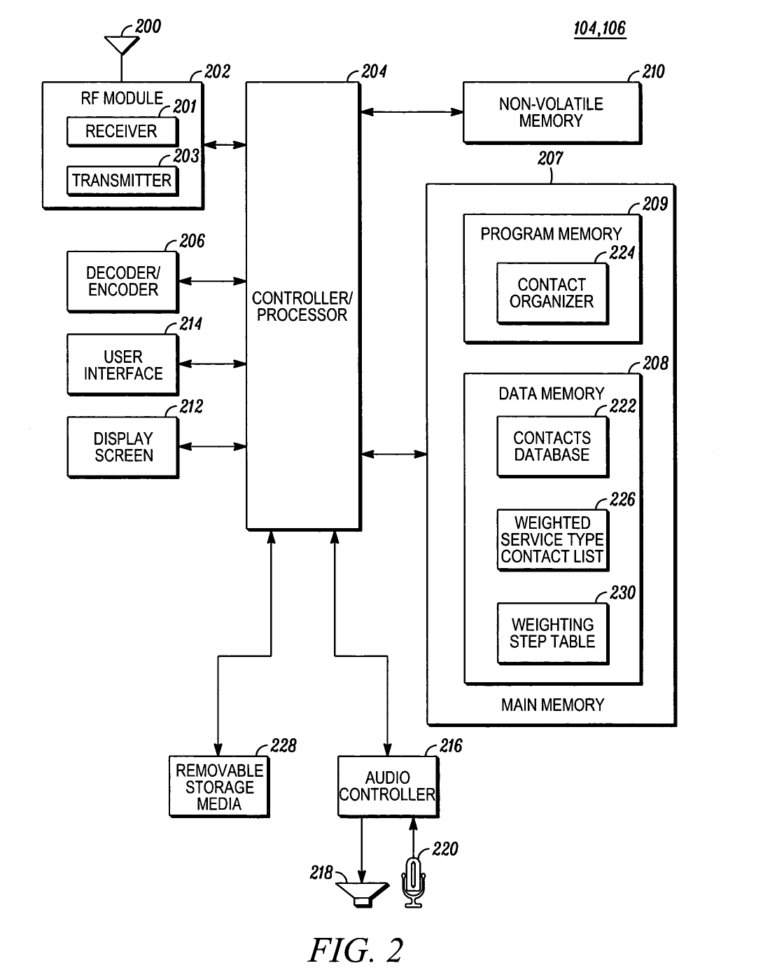

Referring now to FIG. 2, an electrical block diagram of an exemplary wireless communication device 104, 106, according to one embodiment of the present invention, is shown in more detail. Each wireless communication device 104, 106 includes a controller/processor 204, which controls the operation of the wireless device according to computer instructions stored in program memory 209. The wireless communication device 104, 106 also includes a non-volatile memory 210 and a main memory 207. In one embodiment, the main memory 207 includes the program memory 209 and a data memory 208. A contact organizer 224, which is discussed in greater detail below, is contained in program memory 209. The data memory 208 contains a contact database 222, a weighting step table 230, and at least one “service type” contact list 226. Additionally, or alternatively, the contact organizer 224, the contact database 222, the weighting step table 230, and the at least one “service type” contact list 226 may be contained on a removable storage media 228 (e.g., a subscriber interface module (SIM) card, a memory stick, a USB flash drive, or any other portable data storage device), which also functions under the command of the controller/processor 204.

The wireless communication device 104, 106 transmits and receives signals for enabling wireless communication, such as for a cellular telephone, in a well-known manner. For example, when the wireless communication device 104, 106 is in a “receive” mode, the controller/processor 204 operates an RF module 202, which couples an RF signal from the antenna 200 to a receiver 201 in a well known manner. The receiver 201 receives, converts, and demodulates the RF signal, providing a stream of data to the decoder/encoder module 206. The decoder/encoder module 206 decodes the received data, which the controller/processor 204 outputs to a user in a prescribed manner. For example, audio signals are routed through an audio controller 216 to a speaker 218, or external earpiece (not shown). Additionally, received textual or image data is presented to the user on a display screen 212. A receive operational sequence is normally under the control of the controller/processor 204 operating in accordance with computer instructions stored in program memory 209, in a well-known manner.

In a “transmit” mode, the controller/processor 204, for example responding to a direction of a user input (such as a user selecting a contact from a contact list using a user interface 214), controls the audio circuits and couples electronic audio signals from an audio transducer of a microphone 220 to the decoder/encoder module 206, where the audio signals are converted to an encoded data stream for transmission. The controller/processor 204 enables the transmitter circuit 203, which modulates the encoded data onto an RF carrier signal, couples the signal through the antenna 200, and transmits the signal through the wireless portion of the communication network 100 in a manner well-known in the art.

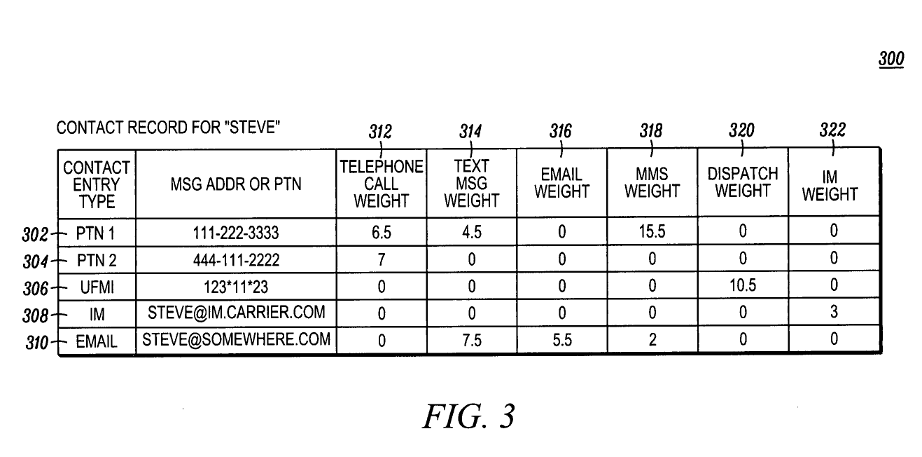

An exemplary contact record 300 from the contacts database 222 for a person named “Steve” is shown in FIG. 3. In this example, Steve has two phone numbers 302, 304 (111-222-3333 and 444-111-2222), a UFMI 306 (123*11*23), an instant messaging address 308 (steve@im.carrier.com), and an email address 310 (steve@somewhere.com). Each contact entry (e.g., each address or phone number) in Steve's contact record is associated with different service types by the use of a weighting factor. In an exemplary embodiment, the weighting factors include a telephone call weight 312, a text messaging weight 314, an email weight 316, a multimedia messaging service (MMS) weight 318, a dispatch weight 320, and an instant messaging weight (IM) 322. For any phone number or address that has not been accessed using a particular service type, the default weighting factor is zero or any other fixed value. In one embodiment, the weighting factors associated with each contact entry are stored in memory and are not shown when displaying the contents of the contact record 300 to the user. Alternatively, the weighting factor(s) may be displayed to the user automatically upon the user's review of the contact record 300 or each particular contact entry, or the weighting factor(s) may be shown only upon specific inquiry from the user (e.g., selection of a “weight” softkey).

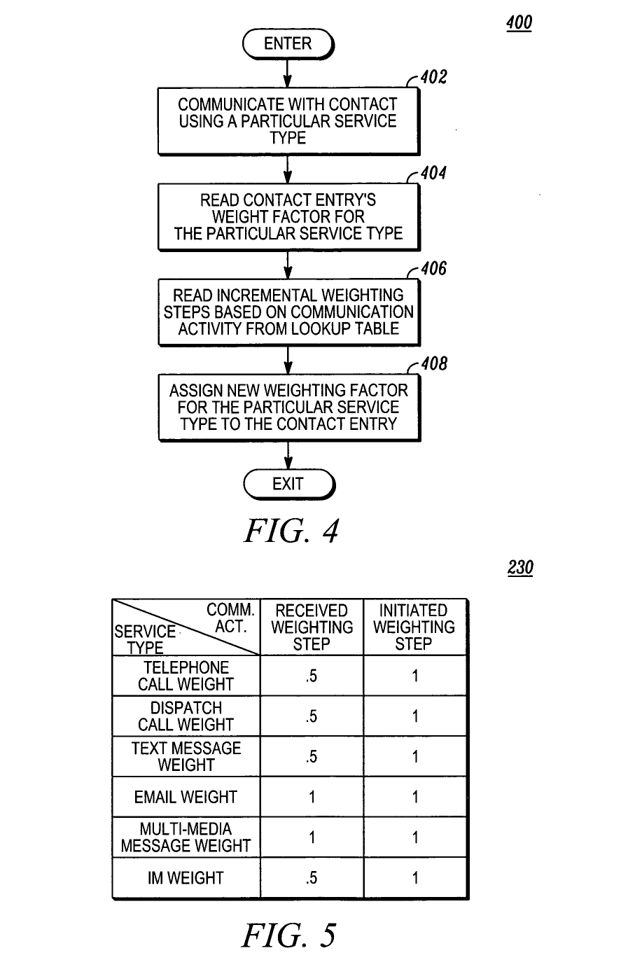

FIG. 4 illustrates an exemplary operational flow diagram 400 for a method of assigning weighting factors to a contact entry in a contacts database 222 according to service type, in accordance with one embodiment of the present invention. Beginning at step 402, the wireless communication device user communicates with a contact from the contact database 222 using a particular service type (e.g., phone call or text message). The communication proceeds as normal until finished, then the contact organizer 224, at step 404, reads the contact entry's current weighting factor for the particular service type. For example, using the exemplary contact record 300 from FIG. 3, if a user receives a call from Steve on cell phone line 1 (PTN1) 302, the associated telephone call weighting factor 312 is 6.5, although the actual weighting factor may be any desired value.

Next, at step 406, the contact organizer 224 reads an incremental weighting step value from the weighting step table 230 based on the communication activity. At step 408, the contact entry is assigned a new weighting factor for the particular service type based on the communication activity. For example, FIG. 5 illustrates an exemplary weighting step lookup table 230. The lookup table 230 contains values for each service type based on attributes of the communication. This exemplary table 230 contains weighting step values based on the origination of the call (e.g., one value if the user initiated the message and another value if the user received the message); however, other embodiments may include weighting factors or weighting step values for length of the message (e.g., number of minutes for a phone call, number of characters in a text message, or number of bytes in a multi-media message, etc.), and/or the amount of time lapsed since the prior communication. The new assignment can be as simple as incrementing the weighting factor according to the value stored in the weighting step lookup table 230 for the message origination. The weighting step and/or weighting factor can be an integer or floating value, since most databases easily support these types of fields. Based on the presumption that the calls a user originates to contacts have a greater interest to the user than calls that the user receives, a higher incremental weight is assigned for calls that the user initiates. However, equal values may be assigned.

Returning to the previous example, where the user receives a call from “Steve” as in FIG. 4, the received weighting step value, 0.5, is retrieved from the weighting step table 230 and added to Steve's PTN1 telephone call weighting factor 312 of 6.5. The resulting weighting factor, (e.g., “7”) is then assigned back to Steve's PTN 1 telephone call weighting factor 312.

Additionally, the weighting factor can be calculated using a more complicated formula. For example, a two hour phone call probably has more significance than a twenty second call. As a result, the weighting factor or incremental weighting step would be higher for the two hour call than for the twenty second call. Likewise, an email that is several paragraphs long is probably more substantial, and consequently worth a larger weight, than one containing only a few words. Also, the amount of time that has lapsed since the last communication with a contact may also be taken into consideration. For example, the user may prefer not to display a contact at the top of the list if he/she has not spoken to that contact for a considerable length of time. Thus, the assigned weighting factor can be a function of many factors, including, but not limited to, the origination or originator of the message, the length of the message, and the time lapsed since the previous communication.

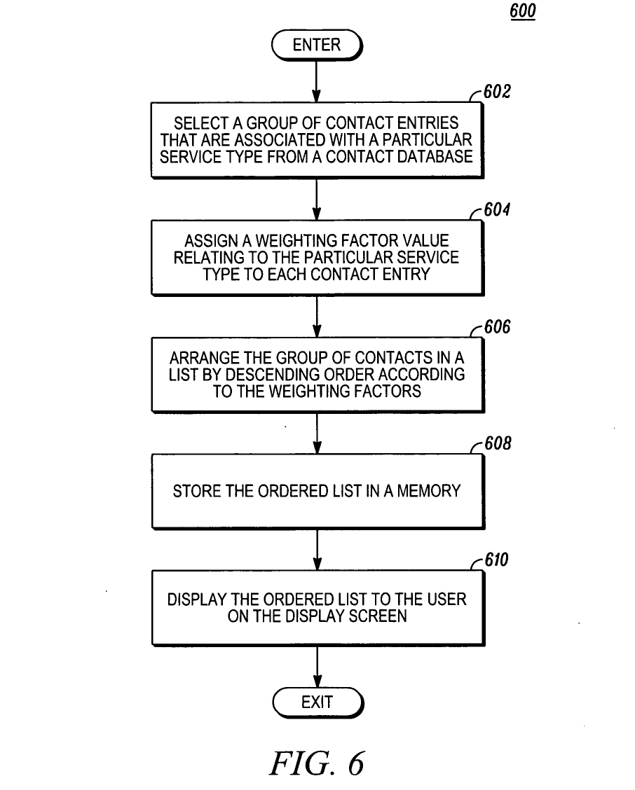

FIG. 6 illustrates an exemplary operational flow diagram 600 for organizing a contacts database 222 for use by a wireless communication device 104, 106 according to the frequency of use of each contact entry for a particular service type, in accordance with one embodiment of the present invention. In an exemplary embodiment, the user requests to view a most frequently used service type contact list by entering or selecting a desired service type from a menu screen displaying a listing of available service types. After the user selects a particular service type, the processor of the communication device 104, 106 displays the ordered list of contacts according to the present invention. For example, at step 602, in response to a request to display a particular weighted service type contact list 226, the contact organizer 224 selects a group of contact entries from the contact database 222 that are associated with the particular service type (e.g., text messaging, email, telephone call, group call, etc.). Next, at step 604, the contact organizer assigns a weighting factor value for the particular service type to each contact entry, in the manner described in the operational flow chart 400 of FIG. 4. At step 606, the contact organizer 224 arranges the selected contact entries in a list, preferably by descending or ascending order according to the weighting factors for the particular service type. Then, the ordered service type contact list 226 is stored in memory, at step 308. Finally, the ordered service type contact list 226 is displayed to the user on the display screen, at step 310.

If a record contains multiple contact entry types that can be used for the queried or desired service type, then the contact organizer 224 will order that contact entry according to the largest weighted value. Alternatively, the contact organizer 224 will order the contact entries using the sum of the weights for the queried service type.

For any contact entries having equal weighting factors, the entries may be arranged alphabetically according to the contact name or in any other manner (e.g., based on a relationship to the user or otherwise, provided that the additional arrangement criteria is stored in the contact record or elsewhere in memory). Alternatively, for contact entries with equal weighting factors, the contact entries may be displayed in an order by the most recently contacted entry.

Additionally, contact entries having an assigned weighting factor less than a predetermined value can be deleted or excluded from the list. For example, any contact entry having a service type weighting factor less than zero may be excluded from the list.

The number of entries in the weighted service type contact list can be set according to a maximum number of entries. In such a case, the displayed entries will be those entries having the highest weighting factors for the desired service type. Additionally, and/or alternatively, contact entries that have not been contacted within a set period of time may be automatically removed from the list.

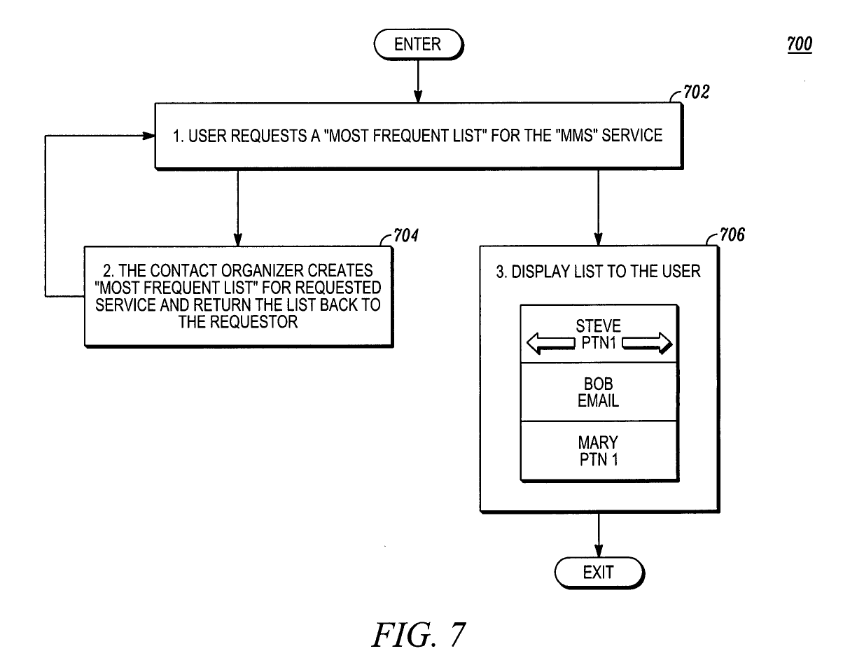

The weighted service type contact list can also be used in conjunction with auto-completion routines. Using auto-completion, when a user enters alphanumeric characters, the routine suggests frequently used words or contacts beginning with the entered characters. To improve the auto-complete routines, the first matches for auto completion would come from the weighted service type contact list. When a user enters at least one alphanumeric character with the user interface 214, the contact organizer 224 displays at least one contact from a selected weighted service type contact list on the screen 212 whose contact name contains a textual character associated with the at least one alphanumeric character. For example, if the user wished to contact Steve using a text messaging service, the user would select the text messaging service list, then enter an “S” on a user interface 212 containing alphanumeric characters (e.g., a keyboard), or a “7” on a user interface 212 (e.g., a telephone keypad). In response to receiving the “S” or the “7”, the contact organizer would display contacts, such as “Steve”, whose name begins with the letter “S” (or in the case of a numeric keypad, any contacts whose name begins with “P”, “R”, or “S”) from which the user may select. To further reduce the amount of displayed contacts, if the user enters “ST” or “78”, only those contacts listed whose names begin with “St” (or the corresponding numerically associated letters) are displayed. 100511 Finally, FIG. 7 illustrates an example of an embodiment of the present invention in use. The user requests a “Most Frequent List” for the “MMS” service, at step 702. The contact organizer 224, at step 704, creates a “Most Frequent List” for the requested MMS service based on the weighting factors assigned to the MMS contact entries of the stored contact records, and returns the list back to the requestor. The MMS service list is displayed to the user, at step 706.

As described above, the present invention encompasses a wireless communication device and method of operation for ordering targeted recipients for a call or other messaging service based on a the weight of usage for a particular type of messaging service. With this invention, wireless communication device users may expediently access his/her most frequently contacts according to service type, without spending extra time and effort manually scrolling through an entire contacts database.

In the foregoing specification, the present invention has been described with reference to specific embodiments. However, one of ordinary skill in the art will appreciate that various modifications and changes may be made without departing from the spirit and scope of the present invention as set forth in the appended claims. For example, the contacts database 222 can be stored in the wireless communications device's internal data memory 208 or to a memory that is externally connectable to the wireless communications device 104, 106 such as, but not limited to, a removable storage media, a local server, or a remote server via the Internet. Further, the method disclosed herein may be executed by a wireline device, such as a personal computer, laptop or notebook computer, or the like having multi-service capability through, for example the Internet. For example, the present invention would be applicable to a PC coupled to the Internet and capable of receiving IP data and IP voice (e.g., through use of a service such as “SKYPE”). Alternatively, the present invention is also applicable to a PC or other computing device having email and instant message access over the Internet. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed is:

1. A method for automatically organizing a plurality of contacts for use by a communication device, the method comprising:
storing a plurality of contact records, each contact record being associated with a corresponding one of the plurality of contacts and including one or more contact entries, each contact entry being associated with at least one service type;
assigning a respective weighting factor to each contact entry of each contact record to produce assigned weighting factors, each assigned weighting factor relating to communication activity involving a contact identified by the particular contact record and a service type associated with the contact entry; and
ordering the plurality of contacts into an ordered list based on the assigned weighting factors for a desired service type.

2. The method of claim 1, wherein each contact record includes:
a contact name; and
at least one of a telephone number, an email address, an instant messaging address, a group identifier, a universal fleet member identifier (UFMI), and a dispatch number.

3. The method of claim 1, wherein the at least one service type is at least one of a telephone call, email, text messaging, multi-media messaging, instant messaging, and dispatch.

4. The method of claim 1, wherein the communication activity includes at least one of quantity of communications, length of communications, time lapsed since last communication, and origination of communication.

5. The method of claim 1, further comprising:
storing the ordered list of contacts in a memory of the communication device, wherein the memory is at least one of a memory internal to the communication device and a memory connectable to the communication device.

6. The method of claim 1, further comprising:
receiving a selection of the desired service type from a user of the communication device prior to ordering the plurality of contacts into the ordered list; and
displaying the ordered list of contacts to the user on a display screen of the communication device.

7. The method of claim 6, further comprising:
initiating a communication in response to selection of a displayed contact.

8. The method of claim 1, further comprising:
excluding from the ordered list any contact for which the assigned weighting factor of the contact entry for the desired service type is less than a predetermined value.

9. The method of claim 1, wherein the step of ordering further comprises:
ordering contacts for which the assigned weighting factors for the desired service type are equal according to a predetermined criteria.

10. The method of claim 9, wherein the predetermined criteria includes at least one of an alphabetical order according to contact name, a time lapsed since last communication, a quantity of communications, and a length of communication.

11. The method of claim 1, further comprising:
communicating with a first contact in the ordered list using the desired service type;
assigning a new weighting factor to a contact entry in a contact record associated with the first contact, the new weighting factor being responsive to the step of communicating; and
re-ordering the ordered list of contacts to take into account the new weighting factor assigned to the contact entry for the first contact.

12. The method of claim 1, further comprising:
excluding from the ordered list any contact for which a time lapsed since a last communication using the desired service type exceeds a predetermined period of time.

13. The method of claim 1, wherein the ordered list is limited to a predetermined number of contacts, the method further comprising:
excluding from the ordered list any contact for which the assigned weighting factor of the contact entry for the desired service type is lower than assigned weighting factors of at least some of the other contact entries for the desired service type.

14. The method of claim 1, further comprising:
in response to entry of at least one alphanumeric character, displaying a contact name of a contact from the ordered list of contacts to a user, wherein the displayed contact name includes at least one textual character associated with the at least one alphanumeric character.

15. The method of claim 1, further comprising:
ordering the plurality of contacts into a second list based on the assigned weighting factors for a second desired service type.

16. A method for automatically organizing a plurality of contacts stored in a memory of a communication device, the method comprising:
storing a plurality of contact records, each contact record being associated with a corresponding one of the plurality of contacts and including one or more contact entries, each contact entry being associated with at least one service type;
assigning a respective weighting factor to each contact entry of each contact record to produce assigned weighting factors, each assigned weighting factor relating to communication activity involving a contact identified by the particular contact record and a service type associated with the contact entry;
ordering the plurality of contacts into an ordered list based on the assigned weighting factors for a desired service type according to at least one of alphabetical order by contact name, time since last communication, quantity of communications, and length of communication;
communicating with a first contact in the ordered list using the desired service type;
assigning a new weighting factor to a contact entry in a contact record associated with the first contact, the new weighting factor being responsive to the step of communicating; and
re-ordering the ordered list of contacts to take into account the new weighting factor assigned to the contact entry for the first contact.

17. A communication device comprising:
a memory for storing a plurality of contact records for a plurality of contacts, each contact record being associated with a corresponding contact and including one or more contact entries, each contact entry being associated with at least one service type; and
a processor communicatively coupled to the memory, the processor assigning a respective weighting factor to each contact entry of each contact record to produce assigned weighting factors, each assigned weighting factor relating to communication activity involving a contact identified by the particular contact record and a service type associated with the contact entry, and ordering the plurality of contacts into an ordered list based on the assigned weighting factors for a desired service type.

18. The communication device of claim 17, further comprising:
a display screen communicatively coupled to the processor, the display screen displaying the ordered list of contacts to a user.

19. The communication device of claim 18, further comprising:
a user interface communicatively coupled to the processor, the user interface facilitating user selection of a displayed contact from the ordered list of contacts.

20. The communication device of claim 17, wherein the communication device is a portable wireless device.
